(19) United States
(12) Patent Application Publication
(10) Pub. No.: US 2013/0076316 A1
(43) Pub. Date: Mar. 28, 2013

(54) METHOD AND ARRANGEMENT IN CONNECTION WITH A CASCADE-FED ASYNCHRONOUS GENERATOR

(71) Applicant: Reijo Kalevi VIRTANEN, Helsinki (FI)

(72) Inventor: Reijo Kalevi VIRTANEN, Helsinki (FI)

(73) Assignee: ABB Oy, Helsinki (FI)

(21) Appl. No.: 13/624,366

(22) Filed: Sep. 21, 2012

(30) Foreign Application Priority Data
Sep. 23, 2011 (FI) 20115935

(51) Int. Cl. H02P 9/10

(52) U.S. Cl. 322/20

(57) ABSTRACT

A method and apparatus are provided for controlling a cascade-fed asynchronous generator in connection with a voltage dip of a network fed by the generator. A frequency converter is connected between the rotor of the asynchronous generator and the network. The method includes measuring the magnitude of the voltage in the network, calculating, on the basis of the voltage in the network, a base value for reactive current to be fed to the network, generating reactive current in the network by the generator, measuring the stator current, determining the actual value of the reactive current in the network, calculating the difference between the base value and the actual value of the reactive current, providing the calculated difference to the frequency converter to serve as an instruction in reactive current, and generating reactive current in the network by the frequency converter in accordance with the instruction in reactive current.

### RELATED APPLICATIONS

This application claims priority under 35 U.S.C. §119 to Finnish Patent Application No. 20115935 filed in Finland on Sep. 23, 2011, the entire content of which is hereby incorporated by reference in its entirety.

### FIELD

The present disclosure relates to cascade-fed asynchronous generators and to controlling such generators in connection with disturbances in networks.

### BACKGROUND INFORMATION

A cascade-fed or double-fed asynchronous generator may be used as a generator for wind power plants to generate electric energy. In the operation of a cascade-fed asynchronous generator, the stator of the generator is connected directly to the network to be fed, whereas the rotor of the generator is connected to the network via a frequency converter. The frequency converter, which includes two controllable bridges and a direct-voltage circuit between them, transmits rotor power from the network to the rotor circuit or from the rotor circuit to the network, depending on the rotation speed of the generator. By means of the frequency converter, the rotor of the generator is excited, depending on the rotation speed, in such a way that the voltage generated in the stator has a desired frequency.

Companies managing electric networks have codes on what kinds of properties generators to be connected to a network should have. These grid codes determine, for example, how a wind power plant should operate in connection with network disturbances. One of these codes relates particularly to supporting a network in connection with voltage dips. The voltage in the network to be fed may crash down, for example, because of a short circuit or corresponding failure. Several network companies require that a wind power plant not be disconnected from the network because of a voltage dip but that the wind power plant should support the network voltage by feeding reactive power to the failed network.

Feeding reactive power to the network is implemented in connection with cascade-fed asynchronous generators by controlling the current of the rotor of the asynchronous generator with a frequency converter in such a way that the excitation of the generator changes, and reactive power is fed to the network via the stator of the generator.

As the grid codes are tightened, it becomes increasingly more important for the reactive network support to be raised to the set level as fast as possible and for the achieved level to be stable. Since a cascade generator is a rotating machine, it is difficult to control it accurately in connection with network disturbances. Desired current can be fed to a network by a frequency converter, and particularly by its network bridge (ISU). In connection with cascade-controlled asynchronous generators, the frequency converter is dimensioned on the basis of the rotor power, which is about one-third of the whole operating power. Thus, rated network support cannot be generated by a frequency converter alone.

### SUMMARY

An exemplary embodiment of the present disclosure provides a method for controlling a cascade-fed asynchronous generator in connection with a voltage dip of a network fed by the generator. A frequency converter is connected between a rotor of the asynchronous generator and the network. The exemplary method includes measuring a magnitude of a voltage in the network, calculating, on the basis of the voltage in the network, a base value for reactive current to be fed to the network, and generating reactive current in the network by the generator. The exemplary method also includes measuring current of a stator of the generator, determining an actual value of the reactive current in the network, and calculating the difference between the base value and the actual value of the reactive current. In addition, the exemplary method includes providing the calculated difference to the frequency converter to serve as an instruction in reactive current, and generating reactive current in the network by the frequency converter in accordance with the instruction in reactive current.

An exemplary embodiment of the present disclosure provides an apparatus for controlling a cascade-fed asynchronous generator in connection with a voltage dip of a network fed by the generator. A frequency converter is connected between a rotor of the asynchronous generator and the network. The exemplary apparatus includes means for measuring a voltage in the network, means for calculating a base value for reactive current to be fed to the network on the basis of the measured voltage, and means for controlling the generator to generate reactive current in the network. The exemplary apparatus also includes means for measuring current of a stator of the generator, and means for determining an actual value of the reactive current in the network. In addition, the exemplary apparatus includes means for calculating the difference between the base value and the actual value of the reactive current, and means for providing the calculated difference to the frequency converter to serve as an instruction in reactive current. The frequency converter is configured to generate reactive current in the network in accordance with the instruction in reactive current.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a principled block diagram of an apparatus implementing a method according to an exemplary embodiment of the present disclosure; and

FIG. 2 shows simulation results of network support according to an exemplary embodiment of the present disclosure.

### DETAILED DESCRIPTION

Exemplary embodiments of the present disclosure provide a method and an apparatus implementing the method in such a manner that solve the drawbacks noted above.

Exemplary embodiments of the present disclosure are based on the idea that when reactive current is fed via the stator of cascade drive, a frequency converter in the rotor circuit of the cascade drive is controlled to generate part of the reactive current. In accordance with an exemplary embodiment, the network converter of the frequency converter is used for generating that part of the reactive current which the stator circuit cannot, due to dynamic changes, generate in the network.

According to these features of the method and apparatus according to the present disclosure, the performance of the network support of the cascade drive can be essentially improved, compared with known techniques, without any changes in the dimensioning of the apparatus.

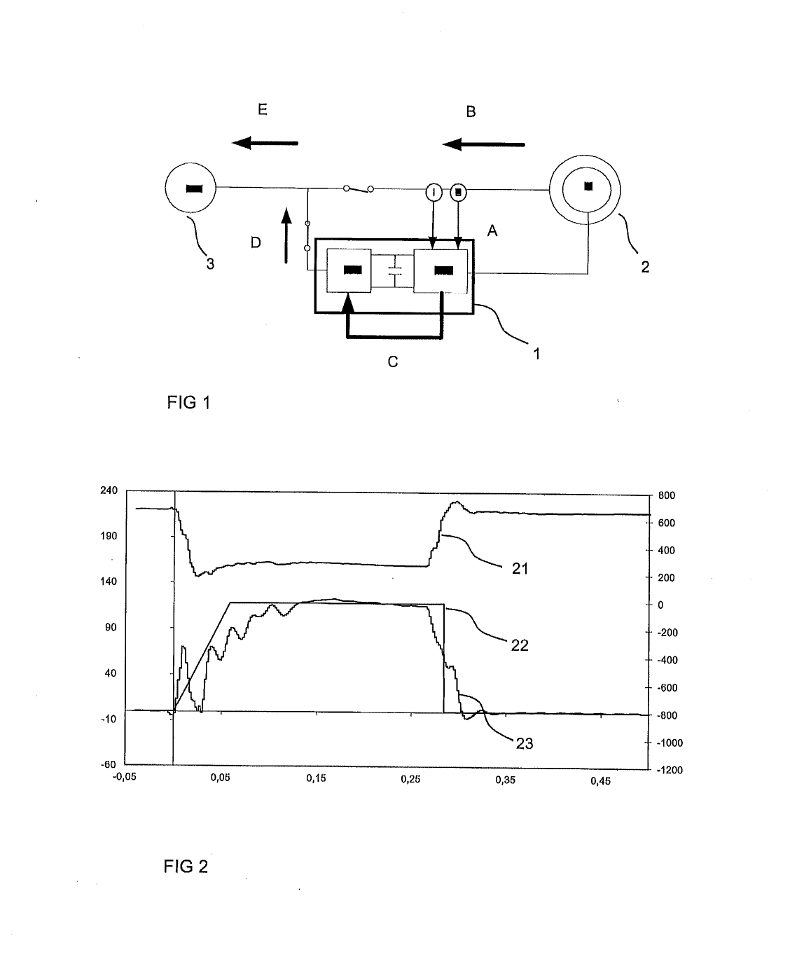

In order to control a cascade-fed generator, a frequency converter is used in a known manner, and it is connected between the rotor of the generator and the network to be fed. The frequency converter includes, in a known manner, two inverters ISU, INU and a direct voltage intermediate circuit between them. FIG. 1 shows a principled view of cascade drive. The inverter ISU of the frequency converter 1 on the side of the network is also called a network bridge or network converter, whereas the inverter INU on the side of the generator is called a load bridge.

During the operation of a cascade-fed generator 2, the inverter INU on the side of the generator obtains measurement data on the voltage of a network 3 and the current of the stator. When a dip in the network voltage resulting from failure in the network is observed, the inverter INU on the side of the generator excites the rotor of the generator in such a way that the generator begins to feed reactive current to the network to support the voltage in the network.

From the measured voltage in the network and the stator current, the reactive current in the network, for example, the current which is generated by the generator to support the voltage in the network, is determined in accordance with the present disclosure.

The reactive current of the network may be determined such that the positive sequence of the voltage of the network is calculated from the measured voltage in the network, and correspondingly, the positive sequence of the stator current is calculated from the measured stator current. From the calculated positive sequences, the reactive current of the network is calculated.

Reactive current by means of positive sequences may be determined for instance in the manner described in publication Jouko Niiranen, “About the Active and Reactive Power Measurements in Unsymmetrical Voltage Dip Ride-through Testing”, WIND ENERGY, 2008 11: 121-131. This publication also discloses other ways to determine reactive current. Determining reactive current is thus known.

On the basis of the measured voltage in the network, an instruction in reactive current, which is determined on the basis of the network requirements, is calculated. When the magnitude of the reactive current generated by the generator is subtracted from the instruction in reactive current, a difference value between the realized reactive compensation and this instruction is obtained. This difference value is provided (e.g., fed), in accordance with an exemplary embodiment of the present disclosure, to the network converter ISU of the frequency converter 1 to serve as an instruction in generating reactive current.

In a case of a network disturbance, voltages and currents are measured nearly continuously, so the instruction in generating reactive current, obtained by the network converter, is frequently updated. Since network converters have quick control properties, reacting to the instructions in reactive current also takes places quickly.

Reactive current may be fed by the network converter until the current limits of the network converter restrict compensation. It is to be noted that the network converter may also be simultaneously used for other functions relating to generation of reactive current via generators.

In FIG. 1, the method of the disclosure is further illustrated by indicating functions with arrow symbols. In accordance with an exemplary embodiment, the method includes measuring (A) the voltage in the network and the current in the stator. When the voltage in the network is reduced, reactive current (B) is fed via the stator of the generator. After the magnitude of the reactive current fed by the generator has been determined, the difference between the instruction in reactive current and the determined reactive current is provided (e.g., fed) (C) to the ISU of the inverter to serve as an instruction in reactive current. The ISU feeds (D) reactive current to the network, and a total compensation (E) is formed of the reactive current (B) to be fed via the stator and the reactive current (D) fed by the ISU.

FIG. 2 shows simulation results of applying the method according to the present disclosure. FIG. 2 shows a symmetric drop in a voltage 21 in the network, and a base value 22 of the reactive current required during it. Curve 23 shows reactive support provided by the stator. Here, it can be seen how compensation 23 implemented by the stator cannot completely comply with the base value 22. This difference between the compensation implemented by the stator and the compensation instruction is the difference value which is fed to the network converter.

When the features of the present disclosure are put into practice, the reactive current generated by the frequency converter makes the compensation provided by cascade drive more efficient and more accurate. Compensation provided by a generator is dynamically inaccurate, and reactive current feed based on an error variable provided by a network converter ISU corrects, owing to its speed, this inaccuracy.

The method of the present disclosure can be implemented by a frequency converter provided with the required measurements of voltages and currents as well as the required control means. In the control units of the frequency converter, there is significant computing capacity (e.g., one or more processors) allowing implementation of the required calculations and control circuits. The required calculations may also be performed in a processor external to the frequency converter.

It will be apparent to a person skilled in the art that as technology advances, features of the present disclosure may be implemented in many different ways. The disclosure and its embodiments are thus not restricted to the examples described above but may vary within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for controlling a cascade-fed asynchronous generator in connection with a voltage dip of a network fed by the generator, wherein a frequency converter is connected between a rotor of the asynchronous generator and the network, by the method comprising:
measuring a magnitude of a voltage in the network;
calculating, on the basis of the voltage in the network, a base value for reactive current to be fed to the network;
generating reactive current in the network by the generator;
measuring current of a stator of the generator;
determining an actual value of the reactive current in the network;
calculating the difference between the base value and the actual value of the reactive current;
providing the calculated difference to the frequency converter to serve as an instruction in reactive current; and
generating reactive current in the network by the frequency converter in accordance with the instruction in reactive current.

2. A method according to claim 1, comprising:
measuring the magnitude of the voltage in the network and the stator current by a load bridge of the frequency converter.

3. A method according claim 1, wherein the generating of the reactive current in the network by the generator includes:
exciting the generator by a load bridge of the frequency converter such that the generator generates the reactive current.

4. A method according to claim 1, wherein the determining of the actual value of the reactive current includes:
calculating a positive sequence of the voltage in the network and a positive sequence of the current of the stator; and
calculating from the positive sequences the actual value of the reactive current in the network.

5. An apparatus for controlling a cascade-fed asynchronous generator in connection with a voltage dip of a network fed by the generator, wherein a frequency converter is connected between a rotor of the asynchronous generator and the network, wherein the apparatus comprises:
means for measuring a voltage in the network;
means for calculating a base value for reactive current to be fed to the network on the basis of the measured voltage;
means for controlling the generator to generate reactive current in the network;
means for measuring current of a stator of the generator;
means for determining an actual value of the reactive current in the network;
means for calculating the difference between the base value and the actual value of the reactive current; and
means for providing the calculated difference to the frequency converter to serve as an instruction in reactive current,
wherein the frequency converter is configured to generate reactive current in the network in accordance with the instruction in reactive current.

6. A method according claim 2, wherein the generating of the reactive current in the network by the generator includes:
exciting the generator by the load bridge of the frequency converter such that the generator generates the reactive current.

7. A method according to claim 6, wherein the determining of the actual value of the reactive current includes:
calculating a positive sequence of the voltage in the network and a positive sequence of the current of the stator; and
calculating from the positive sequences the actual value of the reactive current in the network.

8. A method according to claim 2, wherein the determining of the actual value of the reactive current includes:
calculating a positive sequence of the voltage in the network and a positive sequence of the current of the stator; and
calculating from the positive sequences the actual value of the reactive current in the network.

9. A method according to claim 3, wherein the determining of the actual value of the reactive current includes:
calculating a positive sequence of the voltage in the network and a positive sequence of the current of the stator; and
calculating from the positive sequences the actual value of the reactive current in the network.

10. An apparatus according to 5, comprising:
a load bridge of the frequency converter configured to measure the magnitude of the voltage in the network and the stator current.

11. An apparatus according claim 10, wherein the load bridge of the frequency converter is configured to excite the generator such that the generator generates the reactive current.

12. An apparatus according to claim 5, wherein the means for determining the actual value of the reactive current include:
means for calculating a positive sequence of the voltage in the network and a positive sequence of the current of the stator; and
means for calculating from the positive sequences the actual value of the reactive current in the network.

13. An apparatus according to claim 10, wherein the means for determining the actual value of the reactive current include:
means for calculating a positive sequence of the voltage in the network and a positive sequence of the current of the stator; and
means for calculating from the positive sequences the actual value of the reactive current in the network.

14. An apparatus according to claim 11, wherein the means for determining the actual value of the reactive current include:
means for calculating a positive sequence of the voltage in the network and a positive sequence of the current of the stator; and
means for calculating from the positive sequences the actual value of the reactive current in the network.
